(19) United States
(12) Patent Application Publication
(10) Pub. No.: US 2013/0257734 A1
(43) Pub. Date: Oct. 3, 2013

(54) USE OF A SENSOR TO ENABLE TOUCH AND TYPE MODES FOR HANDS OF A USER VIA A KEYBOARD

(71) Applicants: Stefan J. Marti, Santa Clara, CA (US); Seung Wook Kim, Cupertino, CA (US); Davide Di Censo, Los Altos, CA (US); Eric Liu, Santa Clara, CA (US)

(72) Inventors: Stefan J. Marti, Santa Clara, CA (US); Seung Wook Kim, Cupertino, CA (US); Davide Di Censo, Los Altos, CA (US); Eric Liu, Santa Clara, CA (US)

(21) Appl. No.: 13/435,734

(22) Filed: Mar. 30, 2012

(51) Int. Cl. G06F 3/02

(52) U.S. Cl. 345/168

(57) ABSTRACT

Example embodiments relate to a keyboard-based system that enables a user to provide touch input via the keyboard with one hand and typed input via the keyboard with the other hand. In example embodiments, a sensor detects the user's hands on the top surface of the keyboard. In response, a computing device identifies a first hand and a second hand by analyzing information provided by the sensor. The computing device then assigns the first hand to a touch mode and the second hand to a typing mode. The user may then provide touch input using a visualization of the first hand overlaid on a user interface, while providing typed input with the second hand via the keyboard.

### BACKGROUND

As computing devices have developed, a significant amount of research and development has focused on improving the interaction between users and devices. One prominent result of this research is the proliferation of touch-enabled devices, which allow a user to directly provide input by interacting with a touch-sensitive display using the digits of his or her hands. By minimizing the need for keyboards, mice, and other traditional input devices, touch-based input allows a user to control a device in a more intuitive manner.

### BRIEF DESCRIPTION OF THE DRAWINGS

The following detailed description references the drawings, wherein:

FIG. 1A is a diagram of an example apparatus for enabling a user to interact with a keyboard to simultaneously provide touch input and keyed input to a touch-enabled interface;

FIG. 1B is a diagram of an example apparatus for enabling a user to interact with a keyboard to simultaneously provide touch input and keyed input to a touch-enabled interface, the apparatus including a camera mounted on the keyboard;

FIG. 2 is a block diagram of an example apparatus including a computing device, a keyboard, a sensor, and a display device for enabling simultaneous touch input and keyed input using the keyboard;

FIG. 3 is a block diagram of an example apparatus for enabling simultaneous touch input and keyed input using a keyboard, the apparatus outputting a visualization of a user's hand with applied graphical effects and enabling navigation within a multi-layered touch interface;

FIG. 4 is a flowchart of an example method for utilizing a keyboard to receive touch input via a user's first hand and typed input via a user's second hand;

FIGS. 5A & 5B are flowcharts of an example method for receiving and processing input to enable a keyboard to receive touch input via a user's first hand and typed input via a user's second hand;

FIG. 6 is a diagram of an example interface for applying a regioning effect to a visualization of a user's hand;

FIGS. 7A-7D are diagrams of example interfaces for applying a revealing effect to a visualization of a user's hand; and

FIGS. 8A & 8B are diagrams of example interfaces for applying physics effects to user interface elements based on collisions with a visualization of a user's hand.

### DETAILED DESCRIPTION

As detailed above, touch-sensitive displays allow a user to provide input to a computing device in a more natural manner. Despite its many benefits, touch-based input can introduce difficulties depending on the configuration of the system. For example, in some configurations, a user interacts with a keyboard to provide typed input and interacts directly with a touch-enabled display to provide touch input. In such configurations, the user must frequently switch the placement of his or her hands between the keyboard and the touch display, often making it inefficient and time-consuming to provide input. These configurations are also problematic when the touch display is in a location that it is beyond the reach of the user, such as a situation where the user is viewing and/or listening to multimedia content at a distance from the display.

In other configurations, the display device may not support touch interaction. For example, most televisions and personal computer displays lack hardware support for touch and are therefore unsuitable for use in touch-based systems. As a result, a user of such a display device is unable to take advantage of the many applications and operating systems that are now optimized for touch-based interaction.

Example embodiments disclosed herein address these issues by allowing a user to interact with a physical keyboard that provides conventional keyboard input and the additional capability for multi-touch input. More specifically, example embodiments allow a user to simultaneously provide touch and typed input using the physical keyboard.

For example, in some embodiments, a sensor detects the user's hands on the top surface of the keyboard. In response, a computing device identifies a first hand and a second hand by analyzing information provided by the sensor. The computing device then assigns the first hand to a touch mode and the second hand to a typing mode. The user may then provide touch input using a visualization of the first hand overlaid on a user interface, while providing typed input with the second hand via the keyboard.

In this manner, example embodiments disclosed herein allow a user to interact with a touch-enabled system using a physical keyboard, thereby reducing or eliminating the need for a display that supports touch input. In addition, the user may use one hand to provide touch input to a keyboard, while simultaneously using the other hand to provide keyed input to the keyboard, thereby significantly improving the efficiency of the user's interaction with the computing device. Still further, because additional embodiments allow for navigation between layers of a touch interface, the user may seamlessly interact with a complex, multi-layered touch interface using the keyboard.

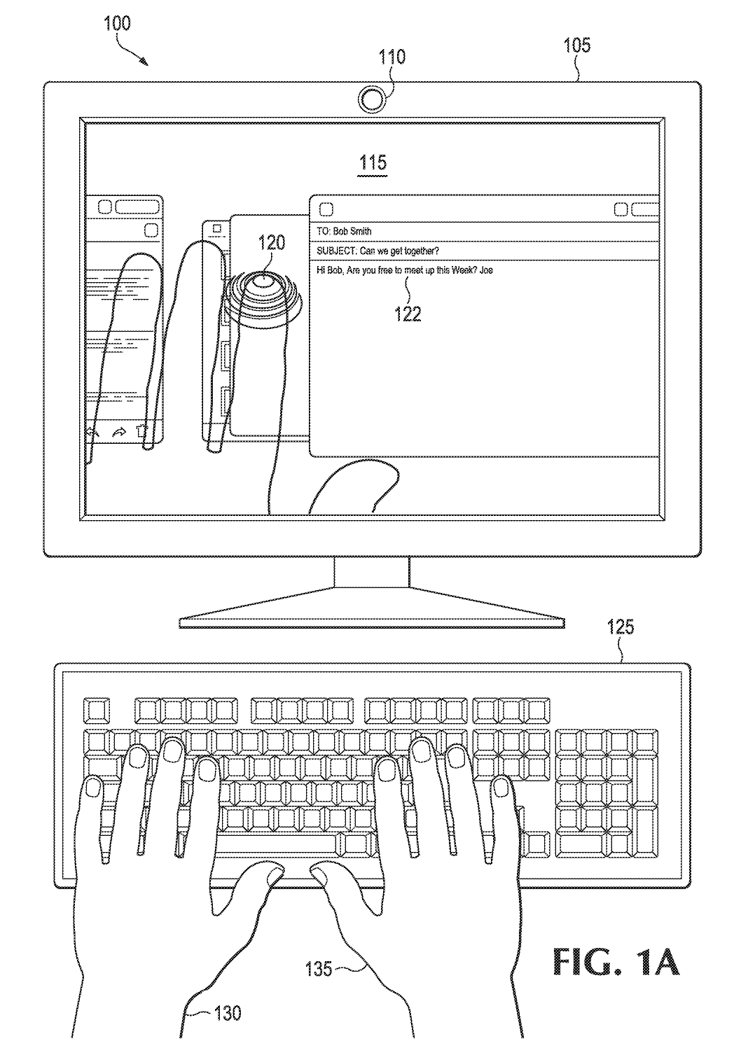

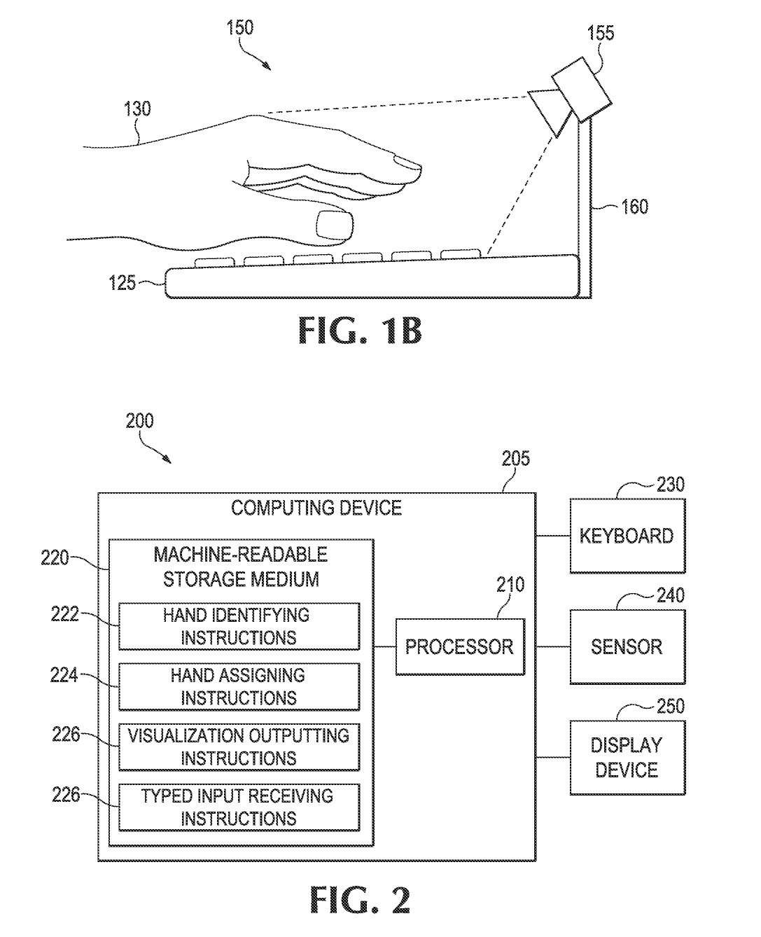

Referring now to the drawings, the following description of FIGS. 1A and 1B provides an overview of example embodiments disclosed herein. Further implementation details regarding various embodiments are provided below in connection with FIGS. 2 through 8.

FIG. 1A is a diagram of an example apparatus 100 for enabling a user to interact with a keyboard 125 to simultaneously provide touch input and keyed input to a touch-enabled interface 115. As illustrated, a display 105 includes a camera 110, which may be a camera with a wide-angle lens integrated into the body of display 105. Furthermore, camera 110 may be pointed in the direction of keyboard 125, such that camera 110 observes movement of the user's hands 130, 135 in a plane parallel to the top surface of keyboard 125. It should be noted, however, that a number of alternative sensors for tracking movement of the user's hands may be used, as described in further detail below in connection with FIG. 2.

Display 105 may be coupled to a video output of a computing device (not shown), which may generate and output a multi-touch interface 115 on display 105. To enable a user to interact with the objects displayed in the multi-touch interface 115, camera 110 detects the user's hands 130, 135 on or above the top surface of the keyboard. As described in further detail below, the computing device then analyzes data from the camera 110 to separately identify the user's two hands and assigns each of the user's hands to either touch mode or type mode. In this example, the device has assigned the user's left hand 130 to the touch mode and the user's right hand 135 to the typing mode.

In response, the computing device then uses data from camera 110 to generate a real-time visualization 120 of the hand in the touch mode (i.e., left hand 130) for output on display 105. For example, as the user moves his or her left hand 130 along or above the surface of keyboard 125, camera 110 provides captured data to the computing device, which translates the position of the user's left hand 130 on keyboard 125 to a position within the user interface. The computing device may then generate the visualization 120 of the user's left hand 130 using the camera data and output the visualization overlaid on the displayed user interface at the determined position.

The user may then perform touch commands on the objects of the user interface 115 by moving his or her left hand 130 and/or digits with respect to the top surface of keyboard 125. For example, the user may initiate a touch event by, for example, depressing one or more keys in proximity to one of his or her digits, pressing a predetermined touch key (e.g., the CTRL key), or otherwise applying pressure to the surface of keyboard 125 without actually depressing the keys. Here, as illustrated, the user activated a touch of the left index finger, which is reflected in hand visualization 120 as a touch of the left index finger on the touch interface 115. Because camera 110 detects movement of the user's entire hand, including all digits, the user may then perform a command on the selected object by gesturing using one or more digits of the left hand 130 along or above the top surface of keyboard 125.

In response, the computing device may use the received camera data to translate the movement of the user's left hand digits on keyboard 125 into a corresponding touch command at a given position within the touch user interface 115. As an example of a multi-touch gesture, the user could perform a pinching gesture in which the left thumb is moved toward the left index finger to trigger a zoom function that zooms out the view with respect to the currently-displayed objects in the touch interface. In embodiments that use a sensor other than a camera, apparatus 100 may similarly detect and process gestures using data from the sensor.

In addition to enabling touch gestures with the left hand 130, apparatus 100 may also enable typing with the user's right hand 135. Thus, after identifying the user's right hand 135 and assigning it to the typing mode, apparatus 100 may omit the visualization of the right hand 135, while processing typed input received via keyboard 125. In particular, when the user types with his or her right hand 135, the computing device may receive a notification of the depressed keys and forward the keyed input to the applications executing within the device. Thus, as depicted in FIG. 1A, the computing device has forwarded input received via the user's right hand 135 to the email application, which has displayed the typed input 122 within the email being composed by the user.

FIG. 1B is a diagram of an example apparatus 150 for enabling a user to interact with a keyboard 125 to simultaneously provide touch input and keyed input to a touch-enabled interface, the apparatus 150 including a camera 155 mounted on the keyboard 125. In contrast to apparatus 100 of FIG. 1A, apparatus 150 may instead include camera 155 with a wide-angle lens mounted to a boom 160, such that camera 155 is pointed downward at the surface of keyboard 125.

The mechanism for mounting camera 155 to keyboard 125 may vary by embodiment. For example, in some embodiments, boom 160 may be a fixed arm attached to either a top or rear surface of keyboard 155 in an immovable position. Alternatively, boom 160 may be movable between an extended and retracted position. As one example of a movable implementation, boom 160 may be a hinge coupling the camera 155 to a rear or top surface of keyboard 125. Boom 160 may thereby move camera 155 between an extended position in which boom 160 is perpendicular to the top surface of keyboard 125 and a retracted position in which boom 160 is substantially parallel to the top surface of keyboard 125 and/or hidden inside the body of keyboard 125. In another implementation, boom 160 may be a telescoping arm that extends and retracts.

In implementations with a movable boom 160, movement of camera 155 between the two positions may be triggered by activation of a predetermined key on keyboard 125 (e.g., a mode toggle key on the keyboard), a button, a switch, or another activation mechanism. Upon selection of the activation mechanism when camera 155 is in the retracted position, boom 160 may rise to the extended position using a spring-loaded mechanism, servo motor, or other mechanism. The user may then return boom 160 to the retracted position either manually or automatically based on a second activation of the predetermined key, button, switch, or other mechanism.

Regardless of the mechanism used to mount and move camera 155, the camera 155 may be pointed at the surface of keyboard 125 and may thereby capture movement of the user's hands 130, 135 along or above the top surface of keyboard 125. Thus, as described above in connection with FIG. 1A, a coupled computing device may output a visualization of a hand that is in a touch mode, while processing keyed input from a hand that is in a typing mode.

FIG. 2 is a block diagram of an example apparatus 200 including a computing device 205, a keyboard 230, a sensor 240, and a display device 250 for enabling simultaneous touch input and keyed input using the keyboard 230. As described in further detail below, a sensor 240 may detect movement of a user's hands and/or digits parallel to a top surface of keyboard 230 and provide data describing the movement to computing device 205. Computing device 205 may then process the received sensor data, generate a visualization of the user's hand that is in the touch mode, and output the interface and overlaid hand visualization on display device 250. Computing device 205 may then perform any touch commands received from the user via the hand in touch mode and process typed data received from the user via the hand in the typing mode.

Computing device 205 may be, for example, a notebook computer, a desktop computer, an all-in-one system, a tablet computing device, a mobile phone, a set-top box, or any other computing device suitable for display of a touch-enabled interface on a coupled display device 250. In the embodiment of FIG. 2, computing device 205 may include a processor 210 and a machine-readable storage medium 220.

Processor 210 may be one or more central processing units (CPUs), semiconductor-based microprocessors, and/or other hardware devices suitable for retrieval and execution of instructions stored in machine-readable storage medium 220. Processor 210 may fetch, decode, and execute instructions 222, 224, 226, 228 to enable simultaneous touch and typed input via keyboard 230. As an alternative or in addition to retrieving and executing instructions, processor 210 may include one or more integrated circuits (ICs) or other electronic circuits that include electronic components for performing the functionality of one or more of instructions 222, 224, 226, 228.

Machine-readable storage medium 220 may be any electronic, magnetic, optical, or other physical storage device that contains or stores executable instructions. Thus, machine-readable storage medium 220 may be, for example, Random Access Memory (RAM), an Electrically Erasable Programmable Read-Only Memory (EEPROM), a storage device, an optical disc, and the like. As described in detail below, machine-readable storage medium 220 may be encoded with a series of executable instructions 222, 224, 226, 228 for processing data from sensor 240 to identify the user's hands, assigning each of the user's hands to either a touch mode or a typing mode, outputting a visualization of the user's hand that is in the touch mode, and receiving typed input from the user's hand that is in the typing mode.

Hand identifying instructions 222 may receive data from sensor 240 and, in response, identify the user's hands as the left hand and the right hand. In particular, hand identifying instructions 222 may initially receive information describing the position of the user's hands and/or digits from sensor 240. The received information may be any data that describes the position and movement of the user's hands and/or digits with respect to keyboard 230. For example, in embodiments in which sensor 240 is a camera, the received information may be a video stream depicting the user's hands with respect to the underlying keyboard surface. As another example, in embodiments in which sensor 240 is a capacitive, infrared, electric field, or ultrasound sensor, the received information may be a “heat” image detected based on the proximity of the user's hands to the surface of keyboard 230. Other suitable data formats will be apparent based on the type of sensor 240.

In response to receipt of the sensor data, hand identifying instructions 222 may analyze the data to identify a first hand of the user and a second hand of the user. Hand identifying instructions 222 may initially process the sensor data to obtain an isolated image of each of the user's hands. For example, when sensor 240 is a camera, hand identifying instructions 222 may subtract an initial background image obtained without the user's hand in the image, thereby resulting in an image of only the user's hands. As an alternative, instructions 222 may detect the outline of the user's hand within the camera image based on the user's skin tone and thereby isolate the video image of the user's hand. In addition or as another alternative, feature tracking and machine learning techniques may be applied to the video data for more precise detection of the user's hand and/or digits. When sensor 240 is a capacitive or infrared touch sensor, the received sensor data may generally reflect the outline of the user's hand, but hand identifying instructions 222 may filter out noise from the raw hand image to acquire a cleaner visualization. Finally, when sensor 240 is an electric field or ultrasound sensor, hand identifying instructions 222 may perform an edge detection process to isolate the outline of the user's hand and thereby obtain the visualization.

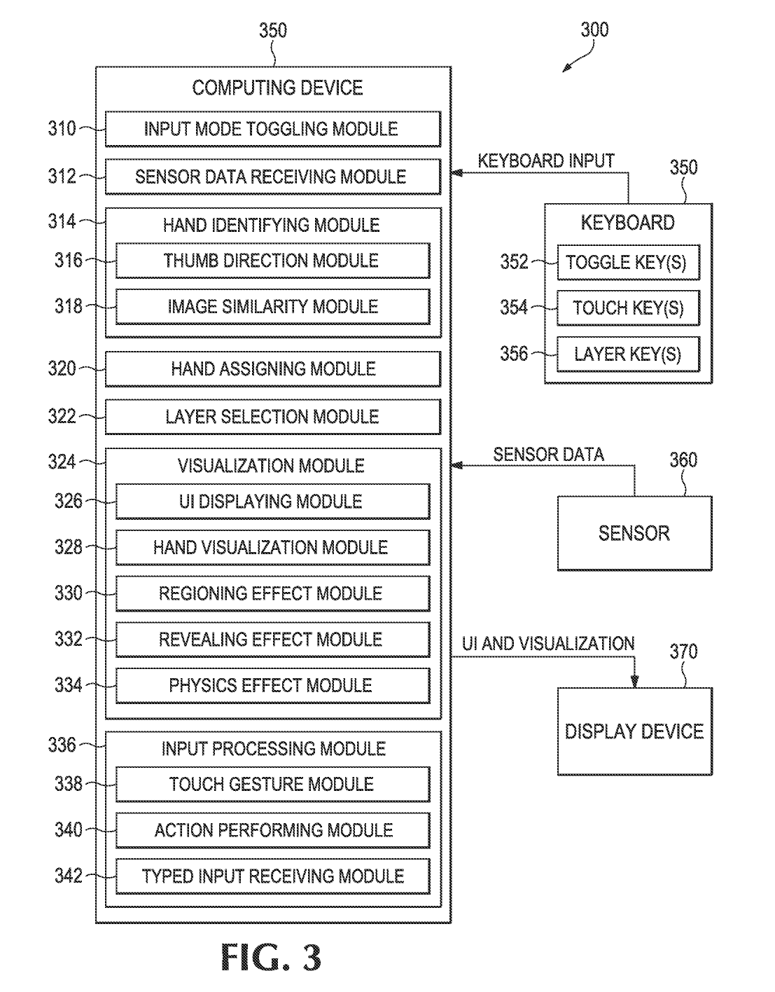

After isolating the images of the user's hands, hand identifying instructions 222 may then analyze the isolated images to determine which image corresponds to the user's left hand and which image corresponds to the user's right hand. For example, hand identifying instructions 222 may analyze each of the images to identify a direction of the user's thumb on each hand, such that the hand with the thumb pointing to the left is identified as the right hand and the hand with the thumb pointing to the right is identified as the left hand. As another example, hand identifying instructions 222 may compare each of the images to known images of left and right hands and identify each hand based on the similarity of each image to the known images. Additional details regarding these two example techniques for identifying the hands of the user are provided below in connection with hand identifying module 312, thumb direction module 314, and image similarity module 316 of FIG. 3.

After identification of each of the hands, hand assigning instructions 224 may then assign the user's hands to either a touch mode or a typing mode. For example, hand assigning instructions 224 may access data that specifies whether the user's left hand is to be assigned to the touch mode or the typing mode and then assign the user's left hand to the corresponding mode. Similarly, hand assigning instructions 224 may access data that specifies the current mode for the user's right hand and assign the user's right hand to the current mode. In some embodiments, as detailed below in connection with input mode toggling module 310 of FIG. 3, the user may toggle each of his or her hands between the touch mode and the typing mode. Based on the assignments of the hands, as detailed below, visualization outputting instructions 226 may output a visualization of each hand in the touch mode, while typed input receiving instructions 228 may process typed input from each hand that is in the typing mode.

Upon receipt of the information describing the movement of the user's hands and/or digits from sensor 240, visualization outputting instructions 226 may generate and output a real-time visualization of the user's hand or hands that are currently assigned to the touch mode. This visualization may be overlaid on the touch-enabled user interface currently outputted on display device 250, such that the user may simultaneously view a simulated image of his or her hand and the underlying touch interface. FIG. 1A illustrates an example hand visualization 115 overlaid on a multi-touch user interface.

Depending on the type of sensor 240, visualization outputting instructions 226 may first perform image processing on the sensor data to prepare the visualization for output. For example, as described above in connection with hand identifying instructions 222, outputting instructions 226 may initially obtain an isolated image of the hand to be outputted using a technique that varies depending on the type of sensor 240.

After processing the image data received from sensor 240, outputting instructions 226 may then determine an appropriate position for the visualization within the displayed touch interface. For example, the sensor data provided by sensor 240 may also include information sufficient to determine the location of the user's hands with respect to keyboard 230. As one example, when sensor 240 is a camera, instructions 226 may use the received video information to determine the relative location of the user's hand with respect to the length and width of keyboard 230. As another example, when sensor 240 is embedded within keyboard 230, the sensor data may describe the position of the user's hand on keyboard 230, as, for example, a set of coordinates.

After determining the position of the user's hand with respect to keyboard 230, outputting instructions 226 may translate the position to a corresponding position within the touch interface. For example, outputting instructions 226 may utilize a mapping table to translate the position of the user's hand with respect to keyboard 230 to a corresponding set of X and Y coordinates in the touch interface. Outputting instructions 226 may then output the visualization of the user's left hand and/or right hand within the touch interface. When sensor 240 is a camera, the visualization may be a real-time video representation of the user's hands. Alternatively, the visualization may be a computer-generated representation of the user's hands based on the sensor data. In addition, depending on the implementation, the visualization may be opaque or may instead use varying degrees of transparency (e.g., 75% transparency, 50% transparency, etc.). Furthermore, in some implementations, outputting instructions 226 may also apply stereoscopic effects to the visualization, such that the hand visualization has perceived depth when display 250 is 3D-enabled.

After computing device 205 displays the visualization of the hand that is in the touch mode, the user may then provide touch input at the location of the visualization by interacting with keyboard 230. For example, as described in further detail below with respect to input processing module 336, the user may provide touch input by depressing keys or applying pressure to the surface of the keys of keyboard 230. As detailed below, action performing module 340 may then perform actions triggered by touch on the objects within the displayed user interface.

Typed input receiving instructions 228 may receive typed input provided to keyboard 230 with the user's hand that is in the typing mode. For example, upon receipt of any typed input from keyboard 230, typed input receiving instructions 228 may determine the location of the particular key on the keyboard and identify the hand of the user that is currently at the location of the key on the keyboard. When the hand that is positioned at the location of the key is currently in the typing mode, typed input receiving instructions 228 may process the input as typical typed input. Thus, computing device 205 may receive the typed input and provide the typed input to an executing application for processing. Alternatively, when the hand that is positioned at the location of the key is in the touch mode, typed input receiving instructions 228 may instead process the input as a touch event, as described below in connection with touch gesture module 338 of FIG. 3.

Keyboard 230 may be a physical keyboard suitable for receiving typed input from a user's hand in a typing mode and providing the typed input to a computing device 205. The user may also interact with keyboard 230 using a hand in a touch mode to provide touch gestures to computing device 205 without interacting directly with display device 250. For example, as described above, the user may activate one or more keys of keyboard 230 with a hand in touch mode to initiate a touch or multi-touch command. After activating the keys, the user may then move his or her hand and/or digits parallel to the top surface of the keyboard to specify the movement used in conjunction with a touch or multi-touch command.

Sensor 240 may be any hardware device or combination of hardware devices suitable for detecting position and movement of a user's hands and digits in a direction parallel to a top surface of keyboard 230. In particular, sensor 240 may detect the user's hands and digits directly on the top surface of keyboard 230 and/or above the surface of keyboard 230. As described above, sensor 240 may then provide sensor data to computing device 205 for identification of the user's hands, assignment of the user's hands to either touch mode or typing mode, and subsequent processing of input from the user's hands.

In some implementations, sensor 240 may be a device physically separate from keyboard 230. For example, sensor 240 may be a camera situated above the surface of keyboard 230 and pointed in a direction such that the camera observes the movement of the user's hands with respect to the top surface of keyboard 230. In these implementations, a visual marker may be included on keyboard 230, such that the camera may calibrate its position by detecting the visual marker. When using a camera to detect movement of the user's hands, apparatus 200 may utilize key presses on keyboard 230 to identify touch events received from the user's hand that is in touch mode, while using the captured video image as the real-time visualization of the user's hands. In camera-based implementations, the camera may be a 2D red-green-blue (RGB) camera, a 2D infrared camera, a 3D time-of-flight infrared depth sensor, a 3D structured light-based infrared depth sensor, or any other type of camera.

In other implementations, sensor 240 may be incorporated into keyboard 230. For example, sensor 240 may be a capacitive, infrared, resistive, electric field, electromagnetic, thermal, conductive, optical pattern recognition, radar, depth sensing, or micro air flux change sensor incorporated into, on the surface of, or beneath the keys of keyboard 230. In this manner, sensor 240 may detect the user's hands and digits on or above the top surface of keyboard 230 and provide sensor data to computing device 205 for identification of the user's hands. Depending on the type of sensor, apparatus 200 may then utilize key presses on keyboard 230 and/or pressure on the surface of the keys to identify touch events triggered by the user's hand that is in touch mode.

Display device 250 may be a television, flat panel monitor, projection device, or any other hardware device suitable for receiving a video signal from computing device 205 and outputting the video signal. Thus, display device 250 may be a Liquid Crystal Display (LCD), a Light Emitting Diode (LED) display, or a display implemented according to another display technology. Advantageously, the embodiments described herein allow for touch interaction with a displayed multi-touch interface, even when display 250 does not natively support touch input.

Based on repeated execution of instructions 222, 224, 226, 228, computing device 205 may continuously update the real-time visualization of the user's hand that is in the touch mode, while processing any touch or multi-touch gestures performed by the user with the hand in the touch mode. Computing device 205 may simultaneously receive typed input from the user's hand that is in the typing mode. In this manner, the user may utilize the hand visualization displayed on display device 250 to simulate direct interaction with the touch interface, while continuing to provide typed input.

FIG. 3 is a block diagram of an example apparatus 300 for enabling simultaneous touch input and keyed using a keyboard 350, the apparatus 300 outputting a visualization of a user's hand with applied graphical effects and enabling navigation within a multi-layered touch interface. Apparatus 300 may include computing device 305, keyboard 350, sensor 360, and display device 370.

As with computing device 205 of FIG. 2, computing device 305 may be any computing device suitable for display of a touch-enabled interface on a coupled display device 370. As illustrated, computing device 305 may include a number of modules 310-342 for providing the keyboard-based touch and type input functionality described herein. Each of the modules may include a series of instructions encoded on a machine-readable storage medium and executable by a processor of computing device 305. In addition or as an alternative, each module may include one or more hardware devices including electronic circuitry for implementing the functionality described below.

Input mode toggling module 310 may allow the user to switch his or her hands between the touch mode and the typing mode. For example, input mode toggling module 310 may toggle the user's left hand between the touch mode and the typing mode in response to a first predetermined input. Similarly, input mode toggling module 310 may toggle the user's right hand between the touch mode and the typing mode in response to a second predetermined input. In some implementations, the predetermined inputs are activations of respective toggle keys 352 on keyboard 350. For example, one key may be used to toggle between modes for the left hand, while another key may be used to toggle between modes for the right hand. In other implementations, each predetermined input is a gesture made using the respective hand. For example, the user may wave his or her left hand back and forth to toggle the left hand between modes, while performing a similar gesture with the right hand to toggle the right hand between modes.

As a result, the user may assign one hand to the touch mode and another to the typing mode, both hands to the typing mode, or both hands to the touch mode. When one hand is in the typing mode and the other is in the touch mode, visualization module 324, described below, may only output a visualization of the hand that is in the touch mode. When both hands are in the touch mode, visualization module 324 may output a visualization of both hands. Finally, when both hands are in the typing mode, computing device 305 may hide the visualization of both hands. In implementations in which the sensor 360 is a keyboard-mounted camera, such as apparatus 150 of FIG. 1B, the camera may move to a retracted position when both hands are in the typing mode and to an extended position when one or more hands are in the touch mode. In this manner, the user may quickly switch between conventional keyboard use and the enhanced touch functionality described herein.

Sensor data receiving module 312 may receive data from sensor 360 describing the movement of the user's hands and/or digits along or above the top surface of keyboard 350. As detailed above in connection with hand identifying instructions 222 of FIG. 2, the sensor data may be, for example, a stream of video information, a “heat” image, or any other data sufficient to describe the position and movement of the user's hands with respect to the keyboard.

Hand identifying module 314 may then analyze the sensor data received by module 312 to identify which hand is the user's left hand and which hand is the user's right hand. As described above in connection with hand identifying instructions 222, module 314 may initially analyze the sensor data to obtain an isolated image of each of the user's hands. Hand identifying module 314 may then rely on either thumb direction module 316 or image similarity module 318 to identify the user's two hands using the isolated images.

When hand identifying module 314 relies on thumb direction module 316, module 316 may initially utilize the isolated image to generate an approximation of a shape of each of the user's hands. As one example, module 316 may execute an algorithm that generates a rough outline of each of the user's hands by grouping pixels based on their proximity to one another. In this manner, for a given hand, the user's thumb forms a first portion of a “blob,” while the user's fingers blend together to form a second portion of the blob.

After obtaining the approximations, thumb direction module 316 may then analyze the approximations to detect a direction of the user's thumb on each hand. Continuing with the previous example, module 316 may identify circles that fit within the boundaries of the generated outline for each hand. Module 316 may rely on the assumption that the circles will be of a smaller diameter within the portion of the outline that includes the thumb than in the portion of the outline that includes the four fingers. Thus, module 316 may determine whether the thumb is on the left side of the hand or the right side of the hand by determining which side of the outline includes the circles of smaller diameter. Finally, module 316 may identify the left hand as the image with the thumb pointing to the right and the right hand as the image with the thumb pointing to the left.

When hand identifying module 314 relies on image similarity module 318, module 318 may initially compare each of the isolated images to a series of known images of left hands and right hands. For example, module 318 may utilize a machine learning technique to perform a pixel-to-pixel comparison between each isolated image and each of the known images to calculate a similarity value. Similarity module 318 may then identify the left hand and right hand of the user based on the similarity of each isolated image to the known images. For example, module 318 may identify each hand as a left hand or right hand based on whether the average similarity value is higher for the set of known left hand images or the set of known right hand images.

After identification of each of the user's hands, hand assigning module 320 may then assign the user's hands to either a touch mode or a typing mode based on the current settings of input mode toggling module 310. In particular, hand assigning module 320 may assign the left hand and the right hand of the user to either the touch mode or the typing mode based on the user-specified settings.

Layer selection module 322 may allow a user to navigate between layers of the multi-touch interface using the hand or hands that are in the touch mode. In particular, in some implementations, the multi-touch user interface with which the user is interacting may include windows in a plurality of stacked layers. For example, in the interface of FIG. 1A, the user is currently interacting with an email composition window that is stacked on top of two another window in the email program. Layer selection module 322 moves the hand visualization between layers, such that the currently-selected layer is displayed in the foreground of the interface and the user may thereby provide touch input to the selected layer. Continuing with the example of FIG. 1A, layer selection module 322 would allow the user to bring the email inbox or the desktop to the foreground of the user interface.

The method for allowing the user to move the visualization between layers varies by implementation. In some implementations, layer selection module 322 may be responsive to layer key(s) 356, which may be one or more predetermined keys on keyboard 350 assigned to change the currently-selected layer. For example, layer key 356 may be a single key that selects the next highest or lowest layer each time the key is depressed. Thus, repeated selection of layer key 356 would rotate through the layers of the interface, bringing each layer to the foreground of the interface when it is selected. Alternatively, one key may be used to select the next highest layer (e.g., the up arrow key), while another key may be used to select the next lowest layer (e.g., the down arrow key).

In other implementations, layer selection module 322 may be responsive to an indication of the distance of the user's hand or digits from the top surface of keyboard 350. For example, sensor 360 may include the capability of detecting the proximity of the user's hand to the top surface of keyboard 350 and may provide an indication of the proximity to layer selection module 322. In response, layer selection module 322 may then selectively bring a particular layer to the foreground based on the indication of height. Thus, in some implementations, when the user's hand is on the surface of keyboard 350, layer selection module 322 may select the lowest layer in the interface (e.g., the desktop of the interface or the lowest window). Alternatively, the layer selection may be inverted, such that the visualization of the user's hand is displayed on the top layer when the user's hand is on the surface of keyboard 350.

In still further implementations, layer selection module 322 may be responsive to a speed of the movement of the user's hand or digits. For example, layer selection module 322 may use the data from sensor 360 to determine how quickly the user has waved his or her hand on or above the top surface of keyboard 350. Layer selection module 322 may then select a layer based on the speed of the movement. For example, when the user very quickly moved his or her hand, layer selection module 322 may select the lowest (or highest) layer. Similarly, movement that is slightly slower may trigger selection of the next highest (or lowest) layer within the interface.

It should be noted that these techniques for selecting the layer are in addition to any layer selection techniques natively supported by the operating system or application. For example, the operating system may include a taskbar listing all open applications, such that the user may move the hand visualization to the desired application in the taskbar and trigger a touch event to bring that application to the foreground. Similarly, in a card-based operating system such as the one illustrated in FIG. 1A, the user may use the hand visualization to select the revealed edge of a background card to bring that card to the foreground.

Furthermore, the layer selection technique may apply to any multi-layered interface. For example, in the examples given above, the layers are generally referred to as cards or windows stacked on top of one another, but the layer selection technique is equally applicable to any other 2.5-dimensional interface that includes user interface elements stacked on top of one another and that allows a user to navigate between different depths within the interface. In addition, the multi-layered interface may also be a three-dimensional interface in which the user interface is configured as a virtual world with virtual objects serving as user interface objects. For example, the virtual world could be a room with a desk that includes a virtual phone, virtual drawers, virtual stacks of papers, or any other elements oriented within the 3D interface. In each of these examples, layer selection module 322 may allow the user to navigate between user interface elements by moving between various depths within the interface (e.g., between stacked objects in a 2.5D interface and within the “Z” dimension in a 3D interface).

Regardless of the technique used for selecting layers, a number of visualization techniques may be used to display the current layer in the foreground. For example, as described further below in connection with UI displaying module 326, the currently-selected layer may be moved to the top of the interface. As another example, the area within the outline of the user's hand may be used to reveal the currently-selected layer within the boundaries of the user's hand. This technique is described further below in connection with revealing effect module 332.

Visualization module 324 may receive sensor data from receiving module 312 and a layer selection from selection module 322 and, in response, output a multi-touch interface and a visualization of the user's hand overlaid on the interface. Thus, module 324 may be implemented similarly to visualization outputting instructions 226 of FIG. 2, but may include additional functionality described below.

User interface displaying module 326 may be configured to output the multi-touch user interface including objects with which the user can interact. Thus, user interface displaying module 326 may determine the currently-selected layer based on information provided by layer selection module 322. Displaying module 326 may then output the interface with the currently-selected layer in the foreground of the interface. For example, displaying module 326 may display the currently-selected window at the top of the interface, such that the entire window is visible.

Hand visualization module 328 may then output a visual representation of the user's hand or hands that are currently in the touch mode overlaid on the multi-touch interface. For example, as described in further detail above in connection with visualization outputting instructions 226 of FIG. 2, hand visualization module 328 may generate a real-time visualization of the user's hand or hands, determine an appropriate location for the visualization, and output the visualization on top of the user interface at the determined location.

In implementations in which sensor 360 is a camera, visualization module 328 may perform additional processing prior to outputting the real-time visualization. For example, if the camera includes a fisheye or wide-angle lens, visualization module 328 may first normalize the video representation of the user's hand or hands to reverse a wide-angle effect of the camera. As one example, visualization module may distort the image based on the parameters of the lens to minimize the effect of the wide-angle lens. Additionally, when the camera is not directly overhead, visualization module 328 may also shift the perspective so that the image appears to be from overhead by, for example, streaming the image through a projective transformation tool that stretches portions of the image. Finally, visualization module 328 may output the normalized and shifted video representation of the user's hand or hands.

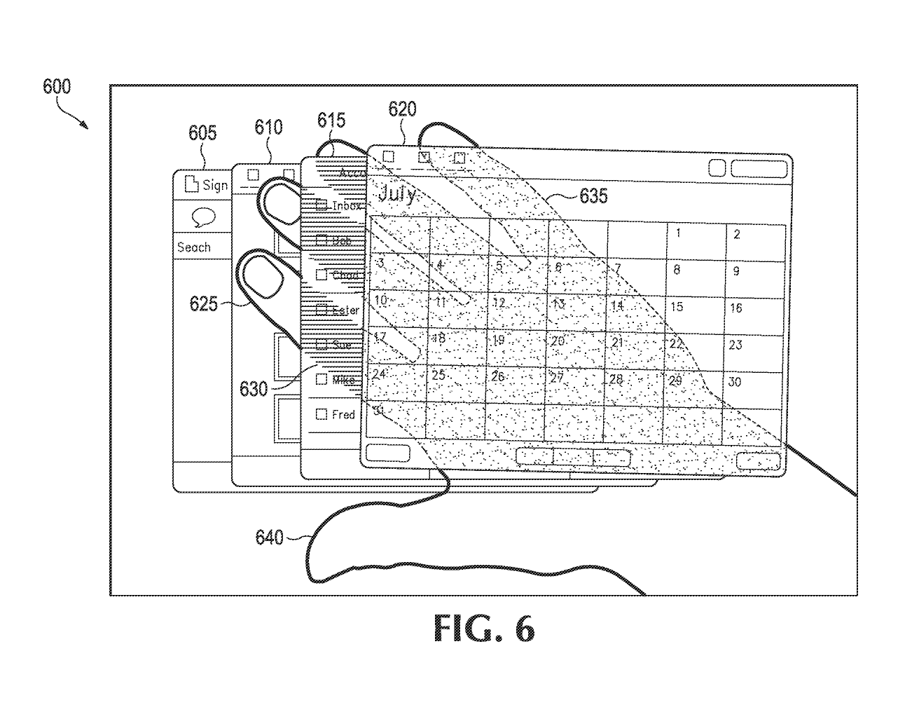

Modules 330, 332, 334 may also apply additional effects to the hand visualization prior to outputting the visualization. For example, when the touch interface is a multi-layered interface, regioning effect module 330 may apply a unique visualization to each section of the visualization that overlaps a different layer of the interface. For example, as illustrated in FIG. 6 and described in further detail below, regioning effect module 330 may first identify each portion of the visualization of the user's hand that intersects a given layer of the interface. Regioning effect module 330 may then apply a different color, shading, transparency, or other visual effect to the visualization of the hand within each intersected layer. In this manner, the visualization of the hand provides additional feedback to the user regarding the layers within the interface and allows a user to increase the accuracy of his or her touch gestures.

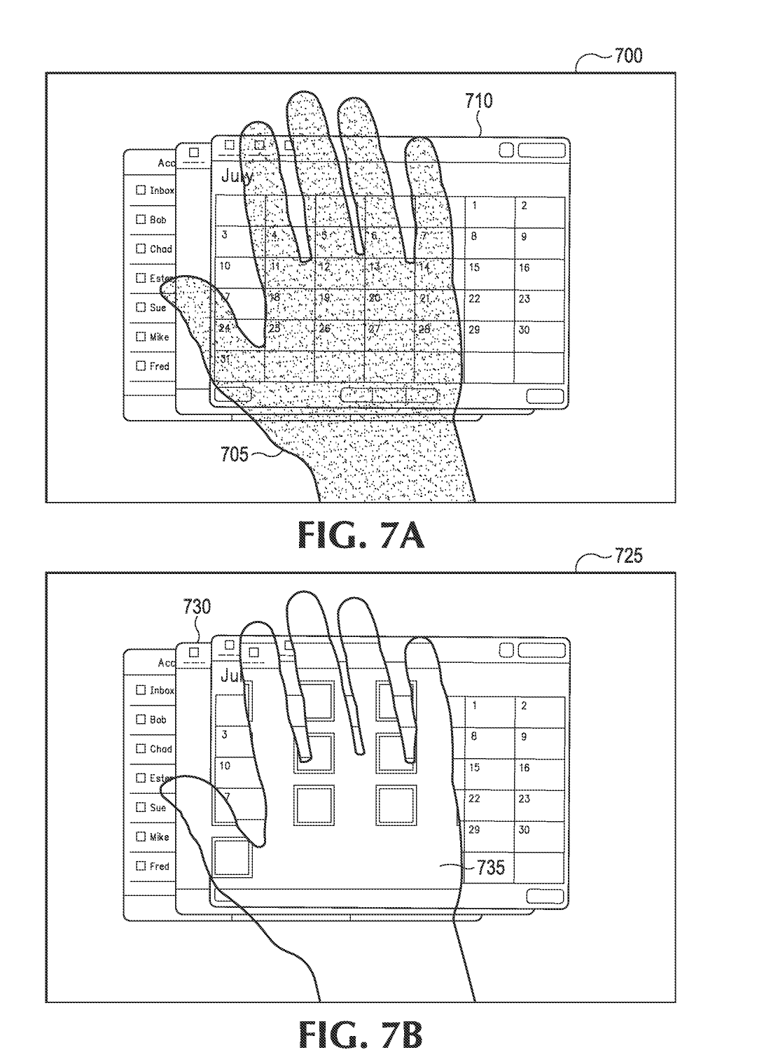

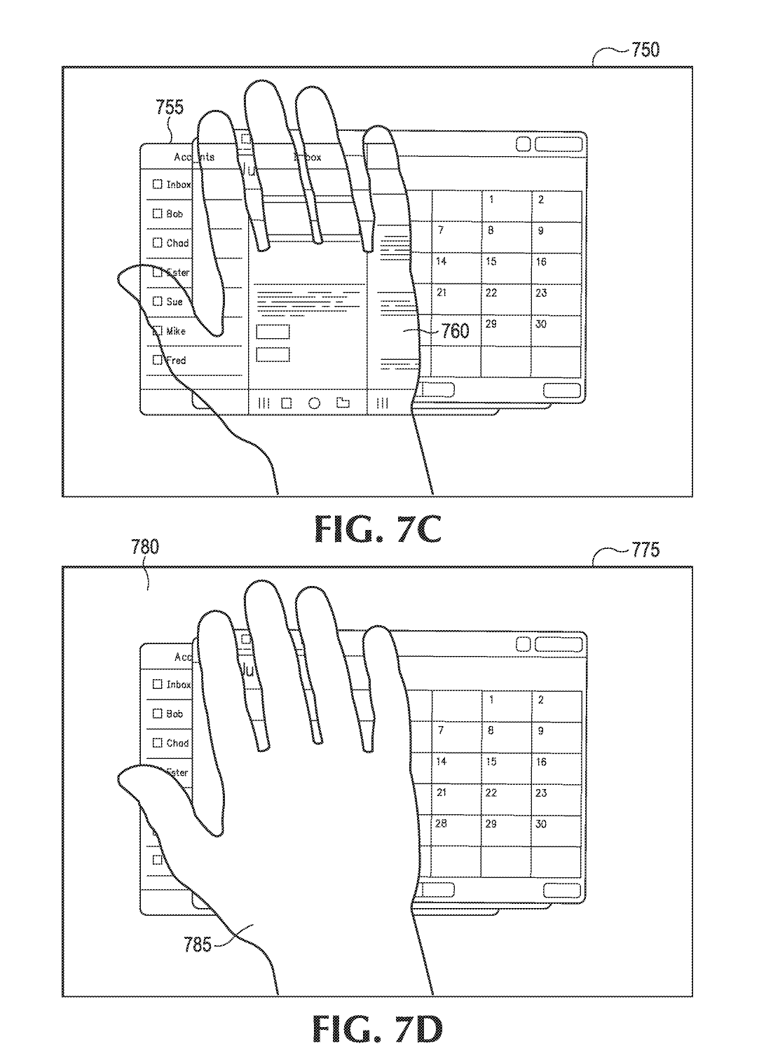

As an alternative to the regioning effect, revealing effect module 332 may apply an effect to change the visualization within the boundaries of the visualization of the user's hand. For example, as illustrated in FIGS. 7A-7D and described in further detail below, revealing effect module 332 may identify the currently-selected layer of the multi-layer user interface and display the current layer within the boundaries of the visualization of the user's hand. Because revealing effect module 332 may only apply the effect to the area within the boundaries of the user's hand, the top layer of the plurality of stacked layers may continue to be displayed outside of the boundaries of the user's hand. The revealing effect thereby enables the user to preview the content of a layer within the stack without moving that layer to the top of the stack.

Finally, physics effect module 334 may apply visual effects to the objects within the user interface based on collisions between the object and the real-time visualization of the user's hand and/or digits. Thus, physics effect module 334 may simulate physical interaction between the displayed objects and the user's hand. For example, physics effect module 334 may allow a user to flick, swipe, push, drag, bounce, or deform a displayed object by simply manipulating the object with the displayed hand visualization.

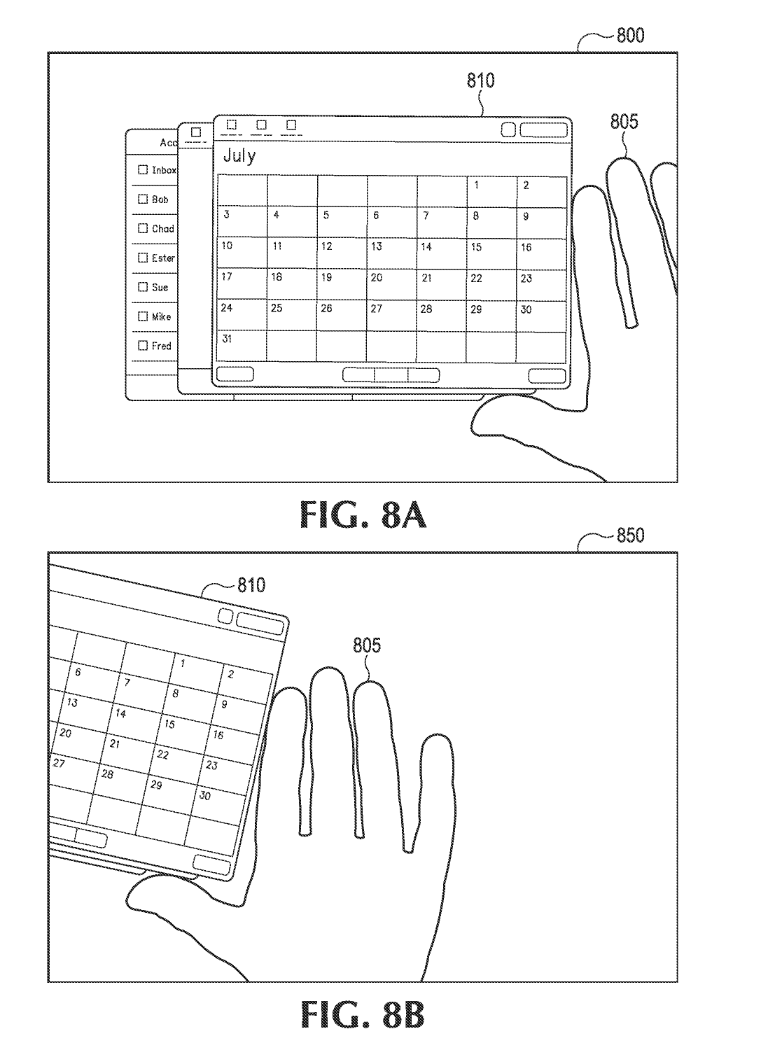

To implement these effects, physics effect module 334 may utilize a software and/or hardware physics engine. The engine may treat each displayed interface element and the hand visualization as a separate physical object and detect collisions between the interface elements and the hand visualization as the user moves his or her hand with respect to keyboard 350. For example, when the user moves his or her hand and the visualization collides with the edge of a window, physics effect module 334 may detect the collision and begin moving the window in the direction of the movement of the user's hand. As another example, when the user “grabs” a window using his or her thumb and index finger, physics effect module 334 may allow the user to deform the window, while pushing or pulling the window around the interface. An example of a physics effect applied to an object is illustrated in FIGS. 8A & 8B and described in further detail below.

Input processing module 336 may be configured to respond to user input provided to keyboard 350 in the form of hand movements by hand(s) in the touch mode and typed keys selected by hand(s) in the typing mode. For example, touch gesture module 338 may initially detect touch events received from a hand in touch mode based on activation of one or more of touch keys 354 or application of pressure to the surface of keyboard 350. Touch keys 354 may be any keys on keyboard for which activation of the key represents a touch event. In some implementations, every key on keyboard 350 except for mode toggle key(s) 352 and layer key(s) 356 may activate a touch event. Thus, the user may activate a single finger touch event by depressing one key of touch keys 354 and may similarly activate a multi-finger touch event by depressing multiple touch keys 354 simultaneously.

The key or keys used for detection of a touch event may vary by embodiment. For example, in some embodiments, the CTRL key, ALT key, spacebar, or other predetermined keys may each trigger a touch event corresponding to a particular digit (e.g., CTRL may activate a touch of the index finger, ALT may activate a touch of the middle finger, the spacebar may activate a touch of the thumb, etc.). As another example, the user may depress any key on keyboard 350 for a touch event and thereby trigger multiple touch events for different digits by depressing multiple keys simultaneously. In these implementations, the digit for which the touch is activated may be determined with reference to the sensor data to identify the closest digit to each activated key. Alternatively, when sensor 240 is a capacitive or infrared touch sensor embedded within keyboard 230, the user may also or instead trigger touch events by simply applying pressure to the surface of the keys without actually depressing the keys. In such implementations, the digit(s) for which a touch event is activated may be similarly determined with reference to the sensor data.

Upon detecting a touch event, touch gesture module 338 may track the subsequent movement of the user's hand and/or digits to identify a gesture coupled with the touch event. For example, when the user has provided input representing a touch of the index finger, module 338 may track the movement of the user's index finger based on the data provided by sensor 360. Similarly, when the user has provided input representing a touch of multiple digits (e.g., the index finger and thumb), module 338 may track the movement of each digit. Module 338 may continue to track the movement of the user's digit or digits until the touch event terminates. For example, the touch event may terminate when the user releases the depressed key or keys, decreases the pressure on the surface of keyboard 350, or otherwise indicates the intent to deactivate the touch for his or her digit(s).

As an example, suppose the user initially activated a multi-touch command by simultaneously pressing the “N” and “9” keys with the right thumb and index finger, respectively. The user may activate a multi-touch command corresponding to a pinching gesture by continuing to apply pressure to the keys, while moving the thumb and finger together, such that the “J” and “I” keys are depressed. Touch gesture module 338 may detect the initial key presses and continue to monitor for key presses and movement of the user's digits, thereby identifying the pinching gesture. Alternatively, the user may initially activate the multi-touch command by depressing and releasing multiple keys and the sensor (e.g., a camera) may subsequently track movement of the user's fingers without the user pressing additional keys. Continuing with the previous example, simultaneously pressing the “N” and “9” keys may activate a multi-touch gesture and sensor 360 may then detect the movement of the user's fingers in the pinching motion.

Action performing module 340 may then perform an appropriate action on the user interface object with which the user has interacted. As the user is moving his or her digits, action performing module 340 may identify an object in the interface with which the user is interacting and perform a corresponding action on the object. For example, action performing module 340 may identify the object at the coordinates in the interface at which the visualization of the corresponding digit(s) is located when the user initially triggers one or more touch events. Action performing module 340 may then perform an action on the object based on the subsequent movement of the user's digit(s). For example, when the user has initiated a touch event for a single finger and moved the finger in a lateral swiping motion, action performing module 340 may scroll the interface horizontally, select a next item, move to a new “card” within the interface, or perform another action. As another example, when the user has initiated a multi-touch event involving multiple fingers, action performing module 340 may perform a corresponding multi-touch command by, for example, zooming out in response to a pinch gesture or zooming in based on a reverse pinch gesture. Other suitable actions will be apparent based on the particular multi-touch interface and the particular gesture performed by the user.

Typed input receiving module 342 may respond to typed input provided by the user via keyboard 350. Upon receipt of a key input, as described above in connection with typing input receiving instructions 228 of FIG. 2, module 342 may initially determine the location of the key on the keyboard and identify the hand of the user that is currently at the location of the key. When the hand that is positioned at the location of the key is currently in the typing mode, module 342 may process the input as typical typed input and may forward the keyed input to an application for processing. Alternatively, when the hand that is positioned at the location of the key is in the touch mode, module 342 may determine that the input should be interpreted as a touch event and therefore forward the keyed input to touch gesture module 338 for processing.

Keyboard 350 may be a physical keyboard suitable for receiving typed input from a user and providing the typed input to a computing device 305. As described above, the user may also interact with keyboard 350 to provide touch gestures to computing device 305 without interacting directly with display device 370. As described above with reference to input mode toggling module 310, mode toggle key(s) 352 may allow a user to switch his or her hands between touch mode and typing mode. As described above with reference to input processing module 336, touch key(s) 354 may be used to trigger touch events by depressing one or more of the keys. Finally, as described above with reference to layer selection module 322, layer key(s) 356 allow the user to toggle the currently-displayed layer within a multi-layered touch interface.

As with sensor 240 of FIG. 2, sensor 360 may be any hardware device or combination of hardware devices suitable for detecting position and movement of a user's hands and digits along or above the top surface of keyboard 350. Thus, sensor 360 may be, for example, a wide-angle camera placed above keyboard 350 or, alternatively, a sensor included within, on the surface of, or below the keys of keyboard 350, such as a group of capacitive sensors, resistive sensors, or other sensors. Additionally, as with display device 250 of FIG. 2, display device 370 may be any hardware device suitable for receiving a video signal including a touch interface and a visualization of the user's hands from computing device 305 and outputting the video signal.

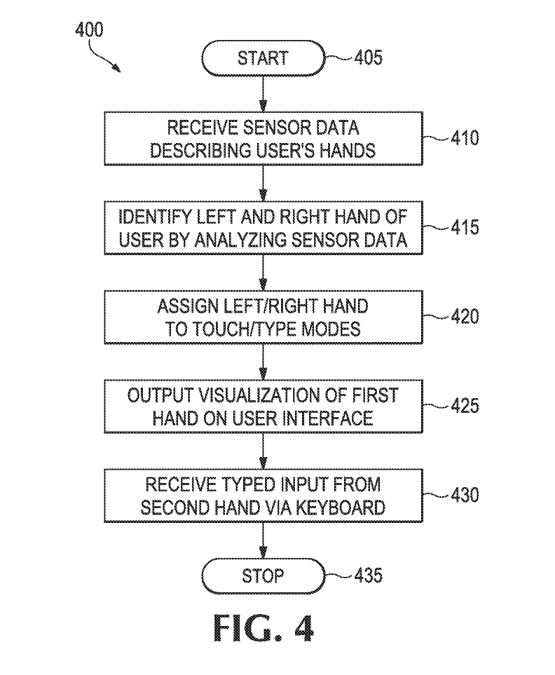

FIG. 4 is a flowchart of an example method 400 for utilizing a keyboard to receive touch input via a user's first hand and typed input via a user's second hand. Although execution of method 400 is described below with reference to apparatus 200 of FIG. 2, other suitable devices for execution of method 400 will be apparent to those of skill in the art (e.g., apparatus 300). Method 400 may be implemented in the form of executable instructions stored on a machine-readable storage medium, such as storage medium 220, and/or in the form of electronic circuitry.

Method 400 may start in block 405 and proceed to block 410, where computing device 205 may receive information describing the position of the user's hands from sensor 240. For example, computing device 205 may receive data from sensor 240 including a video or other image of the user's hands and indicating the relative position of the user's hands on or above keyboard 230.

Next, in block 415, computing device 205 may analyze the data received from sensor 240 to identify the two hands of the user as the left hand and the right hand. For example, computing device 205 may first isolate an image of each of the user's hands. Computing device 205 may then identify each of the user's hands based on the direction of the user's thumb in each hand, by comparing each isolated hand image to a series of known images of left and right hands, or using some other methodology.

After computing device 205 identifies each of the user's hands, method 400 may proceed to block 420, where computing device 205 may assign each of the user's hands to either a touch mode or a typing mode. For example, computing device 205 may access hand assignment data that indicates whether the user has assigned the left hand to the touch mode or the typing mode. Computing device 205 may similarly access the hand assignment data to determine whether the user has assigned the right hand to the touch mode or the typing mode.

Next, in block 425, computing device 205 may use the received sensor data to generate and output a real-time visualization on display device 250 of the user's hand that is in the touch mode. The visualization may be overlaid on top of a touch interface and may be outputted at a position corresponding in location to the relative position of the user's hand with respect to keyboard 230. In addition, computing device 205 may update the visualization in real-time as the user moves his or her hand along or above the surface of keyboard 230. The user may then activate touch events by pressing keys on keyboard 230 or otherwise exerting pressure on the surface of keyboard 230, such that the user may manipulate objects in the touch interface.

In block 430, computing device 205 may receive typed input provided to keyboard 230. Computing device 205 may then determine whether the received typed input originated from the user's hand that is currently in the typing mode. If so, computing device 205 may process the input as regular typed input and therefore forward the typed input to the appropriate application for processing. Computing device 205 may then repeatedly execute blocks 410 to 430 until receipt of a command to disable the simultaneous touch and typing mode. Method 400 may then continue to block 435, where method 400 may stop.

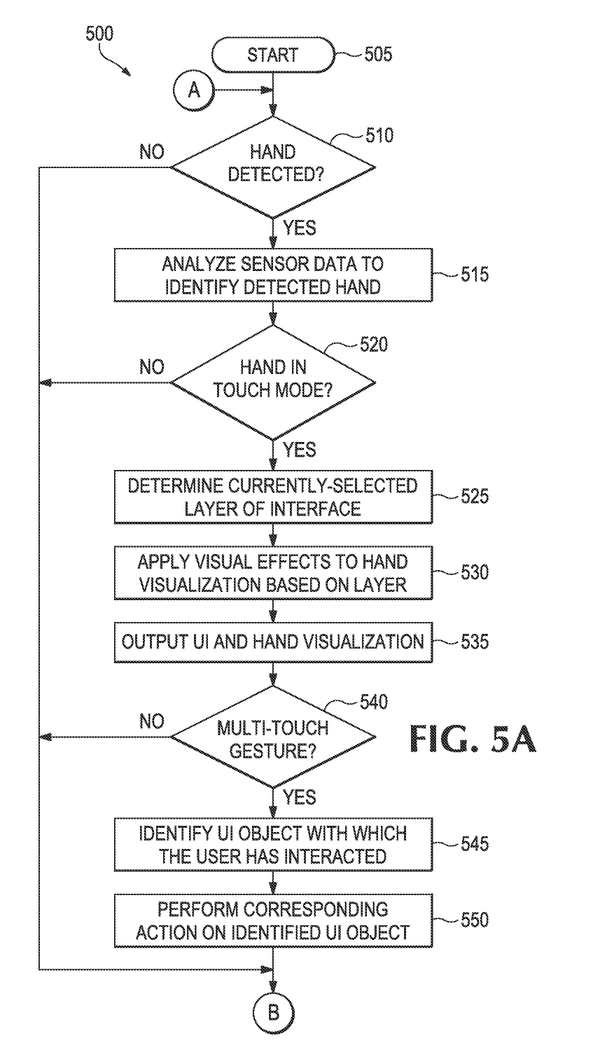

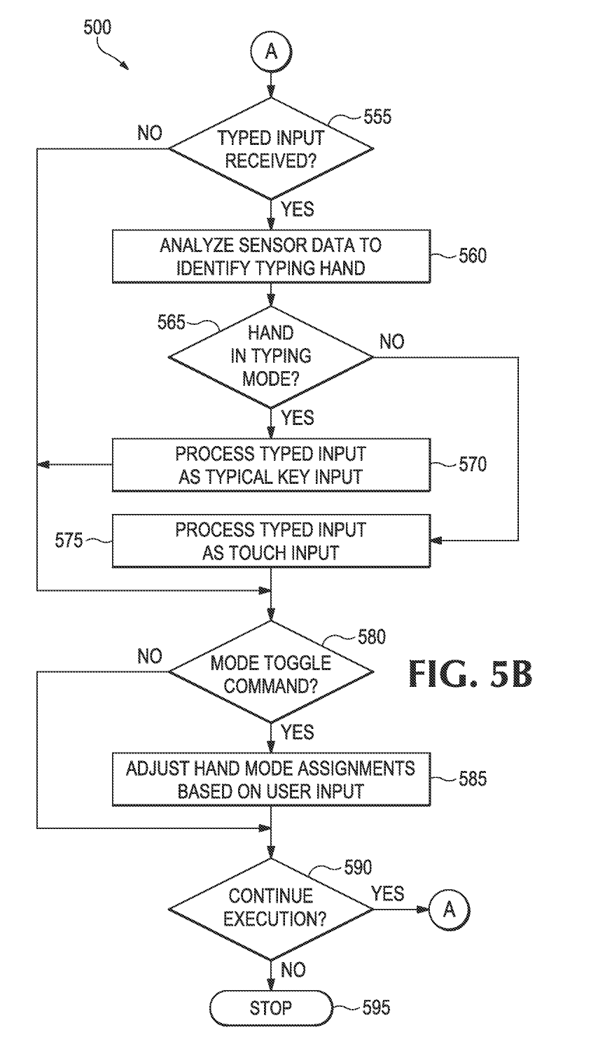

FIGS. 5A & 5B are flowcharts of an example method 500 for receiving and processing input to enable a keyboard 350 to receive touch input via a user's first hand and typed input via a user's second hand. Although execution of method 500 is described below with reference to apparatus 300 of FIG. 3, other suitable devices for execution of method 500 will be apparent to those of skill in the art. Method 500 may be implemented in the form of executable instructions stored on a machine-readable storage medium and/or in the form of electronic circuitry.

Referring initially to FIG. 5A, method 500 may start in block 505 and proceed to block 510, where computing device 305 may determine based on analysis of data from sensor 360 whether the user has positioned or moved his or her hands on or above the top surface of keyboard 350. When computing device 305 does not detect the user's hand, method 500 may continue to block 555, described below with reference to FIG. 5B. Otherwise, when computing device 305 detects the user's hand, method 500 may continue to block 515, where computing device 305 may analyze the sensor data to identify the hand of the user. For example, computing device 305 may analyze the sensor data to identify whether the user's hand is the left hand or the right hand.

Next, in block 520, computing device 305 may determine whether the detected hand is currently assigned to the touch mode or the typing mode. When the hand is assigned to the typing mode, method 500 may proceed to block 555 of FIG. 5B. Otherwise, when the hand is assigned to the touch mode, method 500 may continue to block 525.

In block 525, computing device 305 may determine the currently-selected layer within the multi-layered user interface to be outputted by computing device 305. For example, the user interface may include a plurality of stacked interface elements, such as windows or cards. Computing device 305 may allow the user to navigate between the layers using layer key(s) 356, based on the distance of the user's hand from keyboard 350, or based on the speed of movement of the user's hand.

After determination of the current layer in block 525, method 500 may continue to block 530, where computing device 305 may generate a visualization for the hand that is in touch mode and apply any visual effects to the visualization. For example, computing device 305 may use the sensor data to generate a real-time visualization of the user's hand and to determine an appropriate location for the visualization within the multi-touch user interface. Computing device 305 may then apply one or more visual effects to the visualization based on the currently-selected layer. For example, computing device 305 may apply a regioning effect to change the appearance of portions of the visualization to clearly delineate the overlap of the visualization with each layer of the interface. As another example, computing device 305 may apply a revealing effect to display the currently-selected layer of the interface within the boundaries of the hand visualization. The regioning and revealing effects are described in further detail above in connection with modules 330 and 332 of FIG. 3, respectively.

After generating the hand visualization with any effects, computing device 305 may then output the user interface and hand visualization in block 535. Thus, computing device 305 may output the multi-touch user interface on display device 370 and output the hand visualization overlaid on top of the interface. In this manner, the user may simultaneously view a simulated image of his or her hand and the underlying multi-touch interface.

Next, in block 540, computing device 305 may begin monitoring for touch events and corresponding multi-touch gestures performed by the user with the hand that is in the touch mode. For example, computing device 305 may detect a multi-touch event based on activation of multiple touch keys 354 or application of pressure at multiple points of the surface of keyboard 350. Computing device 305 may then track movement of the user's digits from the points of activation to monitor for a predetermined movement pattern that identifies a particular multi-touch gesture.

When computing device 305 does not detect a touch event and a corresponding multi-touch gesture, method 500 may continue to block 555 of FIG. 5B. Alternatively, when computing device 305 detects a multi-touch gesture, method 500 may then proceed to block 545, where computing device 305 may identify the user interface object with which the user has interacted. For example, computing device 305 may identify the object at the location in the user interface at which the user's digits were positioned when the user initiated the multi-touch gesture. In block 550, computing device 305 may perform an action on the identified object that corresponds to the performed multi-touch gesture, such as zooming, scrolling, or performing another operation.

Referring now to FIG. 5B, in block 555, computing device 305 may determine whether the user has provided typed input via keyboard 350. If no typed input has been received, method 500 may continue to block 580, described in detail below. Alternatively, when typed input has been provided, method 500 may proceed to block 560. In block 560, computing device 305 may analyze the sensor data to identify the hand that is currently typing. For example, computing device 305 may determine the location of the entered key on the keyboard and identify the hand at that position as either the left hand or the right hand.

Next, in block 565, computing device 305 may determine whether the hand identified in block 560 is currently in the typing mode or the touch mode. If the hand is currently in the typing mode, method 500 may continue to block 570, where computing device 305 may process the typed input as typical key input. For example, computing device 305 may forward the keys entered by the user to an application for processing. Alternatively, when computing device 305 determines in block 565 that the hand is currently in the touch mode, method 500 may continue to block 575, where computing device 305 may process the typed input as touch input, as described above in connection with blocks 545 and 550.

After computing device 305 processes the input as key input in block 570 or touch input in block 575, method 500 may continue to block 580. In block 580, computing device 305 may determine whether the user has provided a mode toggle command to switch one or more hands between the touch mode and the typing mode. For example, computing device 305 may determine whether the user has activated one or more of the toggle keys 352 on keyboard 350 or provided a hand gesture indicating a desire to switch the modes for a given hand. If not, method 500 may skip directly to block 590, described in detail below. Otherwise, if the user has indicated a desire to change modes, method 500 may continue to block 585, where computing device 305 may reassign the user's hands to the touch mode or the typing mode based on the user input. Method 500 may then proceed to block 590.

In block 590, computing device 305 may determine whether to proceed with execution of the method. For example, provided that computing device 305 remains powered on and the keyboard-based touch software is executing, method 500 may return to block 510 of FIG. 5A. Alternatively, method 500 may proceed to block 595, where method 500 may stop.

FIG. 6 is a diagram of an example interface 600 applying a regioning effect to a visualization of a user's hand. As detailed above, the regioning effect may be applied to the user's hand or hands that are currently in the touch mode. Example interface 600 may be generated based, for example, on execution of the functionality provided by regioning effect module 330, which is described further above in connection with FIG. 3.

Regioning effect module 330 may initially identify a plurality of portions 625, 630, 635, 640 of the hand visualization that intersect the various layers 605, 610, 615, 620 of the user interface. Referring to interface 600, regioning effect module 330 has identified portion 625 of the visualization as overlapping card 610 of interface 600, portion 630 as overlapping card 615, portion 635 as overlapping card 620, and portion 640 as not overlapping any of the cards.

Regioning effect module 330 may then apply a unique pattern to each portion of the representation of the user's hand. Thus, in the example of FIG. 6, regioning effect module 330 has utilized a video representation of the user's fingertips in portion 625, a striped pattern in portion 630, transparent shading in portion 635, and complete transparency in portion 640. It should be noted that other types of visualizations may be used to distinguish the portions. For example, the portions may be visualized based on the use of different colors, shading patterns, transparencies, textures, and/or other visual features. As a result, the user can quickly identify the location of his or her fingers within the virtual interface based on the different visualizations applied to each portion 625, 630, 635, 640.

FIGS. 7A-7D are diagrams of example interfaces 700, 725, 750, 775 applying a revealing effect to a visualization of a user's hand. As detailed above, the revealing effect may be applied to the user's hand or hands that are currently in touch mode. Example interface 700 may be generated based, for example, on execution of the functionality provided by revealing effect module 332, which is described further above in connection with FIG. 3. Thus, revealing effect module 332 may initially determine which layer of a multi-layer interface the user has currently selected using layer key(s) 356 or any technique for specifying a current layer. Revealing effect module 332 may then display the currently-selected layer within the boundaries of the visualization of the user's hand, while displaying the top layer outside of the boundaries of the visualization.

Referring to interface 700 of FIG. 7A, the user has selected layer 710, which is a card currently displaying a calendar application. As illustrated, revealing effect module 332 has displayed the calendar application within the boundaries of hand visualization 705, which is currently filled using transparent shading. Furthermore, the topmost layer is displayed outside of hand visualization 705, which, in this case, also includes layer 710.

Referring now to interface 725 of FIG. 7B, the user has selected the next layer down, layer 730, which is a card displaying a photo viewing application. As illustrated, revealing effect module 332 has displayed a preview of the photo viewing application within the boundaries of hand visualization 735. In contrast, the topmost layer, the calendar application, continues to be displayed outside of the boundaries of hand visualization 735.

Similar effects are visible in interface 750 of FIG. 7C and interface 775 of FIG. 7D. More specifically, in FIG. 7C, revealing effect module 332 has displayed layer 755, an email application, within the boundaries of hand visualization 760. Finally, in FIG. 7D, revealing effect module 332 has displayed the bottommost layer, desktop 780, within the boundaries of hand visualization 785.

FIGS. 8A & 8B are diagrams of example interfaces 800, 850 applying physics effects to user interface elements based on collisions with a visualization of a user's hand that is currently in the touch mode. As described above in connection with FIG. 3, physics effect module 334 may be configured to detect collisions between the user's hand and user interface objects and, in response, display effects simulating physical interaction between the hand and the objects.

Thus, in interface 800 of FIG. 8A, the user has moved his or her right hand to a right portion of keyboard 350, such that the hand visualization 805 is displayed on the right side of interface 800. Furthermore, as illustrated, the user's thumb and index finger are positioned on the edge of stack 810, which includes three stacked cards, each displaying an application.

As illustrated in interface 850 of FIG. 8B, the user has moved his or her right hand toward the center of keyboard 350, such that the visualization 805 of the user's hand has also moved toward the center of interface 850. In addition, physics effect module 334 has detected the collision between the thumb and index finger of hand 805 and the right and bottom edges of stack 810. In response, physics effect module 334 has applied the movement of hand 805 to stack 810 and therefore pushed stack 810 to the edge of screen. Continued movement of stack 810 by the user would be sufficient to push stack 810 from the screen and thereby close the applications within the stack. Note that, as described above in connection with FIG. 3, physics effect module 334 may apply numerous other effects, such as dragging, bouncing, and deforming displayed objects.

The foregoing disclosure describes a number of example embodiments for enabling a user to provide touch input to a computing device via the keyboard with one hand and typed input via the keyboard with the other hand. In particular, example embodiments utilize a sensor to track movement of a user's hands and subsequently assign each of the user's hands to either a touch mode or a typing mode. In this manner, example embodiments enable a user to efficiently interact with a touch interface via a keyboard by simultaneously providing touch input and keyed input, even when the device's display lacks native touch support. Additional embodiments and advantages of such embodiments will be apparent to those of skill in the art upon reading and understanding the foregoing description.

We claim:

1. An apparatus comprising:
a keyboard;
a sensor for detecting a user's hands on or above a top surface of the keyboard;
a display device; and
a processor to:
identify a first hand of the user and a second hand of the user by analyzing information provided by the sensor,
assign the first hand to a touch mode and the second hand to a typing mode,
output a real-time visualization of the user's first hand overlaid on a touch user interface on the display device to enable the user to perform touch commands by moving the first hand on or above the top surface of the keyboard, and
receive typed input provided to the keyboard with the user's second hand.

2. The apparatus of claim 1, wherein the sensor comprises one or more of a camera placed above the top surface of the keyboard, a capacitive touch sensor, an infrared sensor, and an electric field sensor.

3. The apparatus of claim 1, wherein:
the sensor includes a camera, and
the processor is additionally to output the real-time visualization of the user's first hand as a video representation of the user's first hand obtained by the camera.

4. The apparatus of claim 1, wherein, to identify the first hand and the second hand, the processor is additionally to:
analyze the information provided by the sensor to obtain an isolated image of each of the user's hands,
generate an approximation of a shape of each of the user's hands using each isolated image, and
detect a direction of the user's thumb on each hand in each approximation to identify a left hand and a right hand of the user.

5. The apparatus of claim 1, wherein, to identify the first hand and the second hand, the processor is additionally to:
analyze the information provided by the sensor to obtain an isolated image of each of the user's hands,
compare each of the isolated images to known images of left hands and right hands, and
identify a left hand of the user and a right hand of the user based on a similarity of each isolated image to the known images.

6. The apparatus of claim 1, wherein the processor is additionally to:
toggle the user's first hand between the touch mode and the typing mode in response to a first predetermined input, and
toggle the user's second hand between the touch mode and the typing mode in response to a second predetermined input.

7. The apparatus of claim 6, wherein the first predetermined input is a first key on the keyboard and the second predetermined input is a second key on the keyboard.

8. The apparatus of claim 6, wherein the first predetermined input is a gesture using the first hand and the second predetermined input is a gesture using the second hand.

9. The apparatus of claim 1, wherein:
the touch user interface includes windows in a plurality of stacked layers, and
the processor is additionally to update the touch user interface to display a window of a currently-selected layer in a foreground of the interface based on a position of the real-time visualization within the plurality of stacked layers.

10. The apparatus of claim 9, wherein the processor is additionally to:
modify the currently-selected layer of the plurality of stacked layers based on at least one of:
a user selection of a predetermined key on the keyboard,
a distance of the user's first hand from the top surface of the keyboard, and
a speed of movement of the user's first hand in a direction parallel to the top surface of the keyboard.

11. The apparatus of claim 9, wherein, in outputting the real-time visualization, the processor is additionally to:
identify a plurality of portions of the real-time visualization of the user's first hand, each portion intersecting a respective layer of the plurality of stacked layers, and
apply a unique visualization to each identified portion of the plurality of portions of the real-time visualization.

12. The apparatus of claim 9, wherein, the processor is additionally to:
display the currently-selected layer in the foreground of the interface within the boundaries of the real-time visualization of the user's first hand, and
display a top layer of the plurality of stacked layers in the foreground of the interface outside of the boundaries of the real-time visualization of the user's first hand.

13. The apparatus of claim 1, wherein the processor is additionally to:
simulate physical interaction between a displayed object and the user's first hand by applying a physics effect to the displayed object based on a collision between the displayed object and the real-time visualization of the user's first hand.

14. A machine-readable storage medium encoded with instructions executable by a processor of a computing device for enabling touch interaction via a keyboard, the machine-readable storage medium comprising:
instructions for receiving data from a sensor that detects movement and a position of a user's hands on or above a top surface of the keyboard;
instructions for identifying a left hand of the user and a right hand of the user by analyzing the data received from the sensor;
instructions for assigning a first hand of the user's hands to a touch mode and a second hand of the user's hands to a typing mode;
instructions for displaying a visualization of the user's first hand on a display of the computing device overlaid on an existing touch interface to enable touch input via movement of the first hand; and
instructions for receiving typed input provided to the keyboard with the user's second hand.

15. The machine-readable storage medium of claim 14, wherein the instructions for identifying are configured to:
analyze the data received from the sensor to obtain an isolated image of each of the user's hands,
generate an approximation of a shape of each of the user's hands using each isolated image, and
detect a direction of the user's thumb on each hand in each approximation to identify the left hand and the right hand.

16. The machine-readable storage medium of claim 14, wherein the instructions for identifying are configured to:
analyze the data received from the sensor to obtain an isolated image of each of the user's hands,
compare each of the isolated images to known images of left hands and right hands, and
identify the left hand and the right hand based on a similarity of each isolated image to the known images.

17. The machine-readable storage medium of claim 14, wherein the instructions for assigning are configured to assign the user's hands to the touch mode and the typing mode based on a user specification of a mode for the left hand and a mode for the right hand.

18. A method for enabling touch and text input using a keyboard in communication with a computing device, the method comprising:
using a sensor to obtain sensor data regarding a user's hands on the keyboard;
identifying a first hand of the user and a second hand of the user by analyzing the sensor data;
assigning the first hand to a touch mode and the second hand to a typing mode;
outputting a visualization of the user's first hand on the display device, wherein the visualization of the user's first hand is overlaid on a touch interface of an application; and
forwarding, to the application, typed input provided to the keyboard with the user's second hand.

19. The method of claim 18, wherein the assigning comprises:
assigning the user's hands to the touch mode and the typing mode based on a user specification of a mode for each hand.

20. The method of claim 18, wherein identifying the first hand and the second hand comprises at least one of:
identifying a left hand and a right hand of the user by analyzing the sensor data to obtain an image of each hand and to detect a direction of the user's thumb in each image, and
identifying the left hand and the right hand of the user by analyzing the sensor data with reference to known images of left hands and right hands.
